(19) United States
(12) Patent Application Publication
(10) Pub. No.: US 2007/0140538 A1
(43) Pub. Date: Jun. 21, 2007

(54) Method for processing unenhanced medical images

(76) Inventors: James Doran, Rochester, NY (US); Michael D. Heath, Rochester, NY (US)

Correspondence Address: Pamela R. Crocker;Patent Legal Staff, Eastman Kodak Company, 343 State Street, Rochester, NY, 14650-2201, US

(21) Appl. No.: 11/501,400

(22) Filed: Aug. 9, 2006

Related U.S. Application Data
(60) Provisional application No. 60/751,867, filed on Dec. 20, 2005.

(51) Int. Cl. G06K 9/00

(52) U.S. Cl. 382/128

(57) ABSTRACT

A method for distributing digital medical images between an capture device and a image display device remote from the capture device when a user desires to reprocess an enhanced digital medical image at the image display device. The user initiates a request from the image display device for the unenhanced digital medical image stored at the image capture device, and the request from the image display device is transmitted to the image capture device. The unenhanced digital medical image is then transmitted from the image capture device to the image display device.

### CROSS-REFERENCE TO RELATED APPLICATIONS

Reference is made to, and priority is claimed from, U.S. Patent Application Ser. No. 60/751,867, provisionally filed Dec. 20, 2005, commonly assigned, and incorporated herein by reference.

### FIELD OF THE INVENTION

This invention relates to digital medical imaging, and in particular to the storage and retrieval of medical images, such as from a digital medical image capture device or a digital medical image archive system.

### BACKGROUND OF THE INVENTION

Examples of known digital medical acquisition/capture devices (i.e., modalities) include computed radiography (CR), direct digital radiography (DR), computed tomography (CT) and magnetic resonance (MR), among others. Picture Archiving and Communication Systems (PACS) can comprise digital medical image archives and diagnostic viewing workstations. A digital medical imaging system is comprised of digital medical acquisition capture devices, PACS, and optional equipment such as laser film printers.

A typical workflow for digital medical imaging is to first acquire the medical image at a modality and then enhancement process the digital image on the same modality. This image processing enhances the visibility of features in the image to improve the ability of a medical professional to rapidly interpret images. Image enhancement processing can then be followed by transmitting the enhanced image from the modality to an archive, workstation, printer, or the like. Transmission of the image from the modality to a PACS is typically initiated by the modality, so that the modality can be considered to “push” the image to the PACS.

Commonly assigned U.S. Ser. No. 09/712,423 (Kohm), filed on Nov. 14, 2000 is directed to a method and apparatus for archiving and distributing enhanced and unenhanced digital medical images.

In some situations, the modality retains a copy of the unenhanced digital medical image for a finite period of time, which can depend on the modality's storage capacity and system throughput. In some systems, the retention of the unenhanced image by the modality allows for alternative image enhancement processing. This reprocessing of an image can be performed in response to a request by a radiologist, for example, reprocessing due to insufficient or sub-optimal quality of the original enhanced image.

An alternative workflow to providing the radiologist with an image processed with alternative enhancement would be to provide the radiologist with unenhanced image data at the diagnostic workstation and provide image enhancement processing on that workstation.

The DICOM standard (Digital Imaging and Communications in Medicine PS 3.3-2003, National Electrical Manufacturers Association, 2003) addresses the storage and transmission of image data that is enhanced or unenhanced. The concept is presented in the DX Information Object Definition (IOD) by the presence of the Presentation Intent Type attribute. This tag may have the value of “FOR PRESENTATION” or “FOR PROCESSING”. If the value of the tag is “FOR PRESENTATION”, the image has been enhanced such that the image may be displayed without additional processing required. If the value of the tag is “FOR PROCESSING”, the image must undergo additional enhancement processing prior to display and interpretation. The intent of “FOR PROCESSING” image data is to allow more capable systems which can perform the required enhancement processing to do so while still using a DICOM image object while preserving the capability to provide image data that is display-ready by the use of “FOR PRESENTATION”. The standard does not however, indicate how images stored with different image processing levels should be managed within a PACS. The standard addresses the representation and labeling of such data.

The design of a digital medical imaging system balances the performance and cost of digital media for long-term (essentially infinite) storage of patient images, a communications network, and image display workstations while still meeting workflow and image quality requirements. As the capacity and speed of data transmission increases, the desire to minimize the cost of digital storage systems becomes an area of increasing focus for digital medical imaging system architects. Since non-lossless image compression schemes are generally viewed as being unacceptable in medical imaging systems, minimizing storage redundancy is an effective way of reducing overall system cost.

The present invention is directed to a method of managing both enhanced and unenhanced digital medical images within a PACS while minimizing storage redundancy.

### SUMMARY OF THE INVENTION

It is an object of the present invention to provide a method to request, or pull, an unenhanced digital medical image from a digital medical acquisition device.

Any objects provided are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a method for distributing digital medical images between an image capture device and an image display device remote from the capture device. The method includes the steps of: accessing an enhanced digital medical image at the image display device, the enhanced digital medical image being generated by applying a first image processing to an unenhanced digital medical image acquired by and stored at the image capture device; allowing a user to initiate a request from the image display device for the unenhanced digital medical image; transmitting the request from the image display device to the image capture device; and transmitting the unenhanced digital medical image from the image capture device to the image display device.

The present invention recognizes the existence of an enhanced digital medical image that has been pushed to a digital medical image archive or image display device, and where conditions are such that it is advantageous for the image display device to enhance the digital medical image, or apply some form of computer aided analysis. The method provides for the archive or image display device to request, or pull, an unenhanced copy of the same digital medical image from the original capture device.

An advantage is the retaining of information regarding how DICOM clients and providers communicate and transmit images when the enhancement performed by the digital medical image capture device is sufficient.

Further, when the enhanced digital medical image is of insufficient or sub-optimal quality, the request for the unenhanced image requires no human intervention at the digital medical image capture device.

Still further, on receipt of the unenhanced digital medical image as requested by the digital medical image archive or image display device, the original enhanced copy of the digital medical image becomes redundant and can be discarded, thereby offering a reduction in archive storage over separate representation of the enhanced and unenhanced digital medical images.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1A is a diagrammatic illustration showing a digital medical imaging system, suitable for practicing the present invention, comprised of capture devices, a communications network, archive, and an image display device, such as a diagnostic viewing workstation.

FIG. 1B generally illustrates the operation of a computed radiography device.

FIG. 1C generally illustrates the operation of a digital radiography device.

FIG. 1D more particularly illustrates the image archive of FIG. 1A.

FIG. 2 is a diagrammatic illustration showing a digital capture device transferring enhanced digital medical images to a PACS.

FIG. 3 is a diagrammatic illustration showing a query initiated by a diagnostic workstation for an unenhanced copy of a digital medical image from the device that originally captured the image.

FIG. 4 shows an exemplary display of the diagnostic workstation.

FIG. 5 shows a diagrammatic illustration of the method of the present invention.

### DETAILED DESCRIPTION OF THE INVENTION

The following is a detailed description of the preferred embodiments of the invention, reference being made to the drawings in which the same reference numerals identify the same elements of structure in each of the several figures.

In the following description, a preferred embodiment of the present invention will be described as a software program. Those skilled in the art will recognize that the equivalent of such software may also be constructed in hardware. Because image manipulation algorithms and systems are well known, the present description will be directed in particular to algorithms and systems forming part of, or cooperating more directly with, the method in accordance with the present invention. Other aspects of such algorithms and systems, and hardware and/or software for producing and otherwise processing the image signals involved therewith, not specifically shown or described herein may be selected from such systems, algorithms, components and elements known in the art.

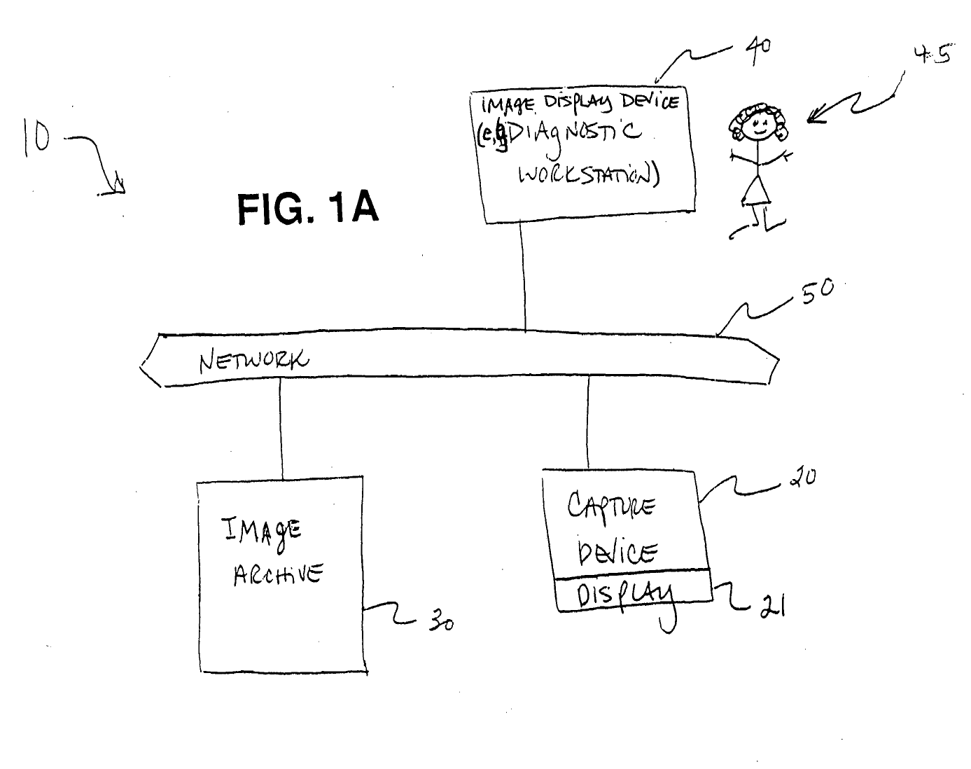

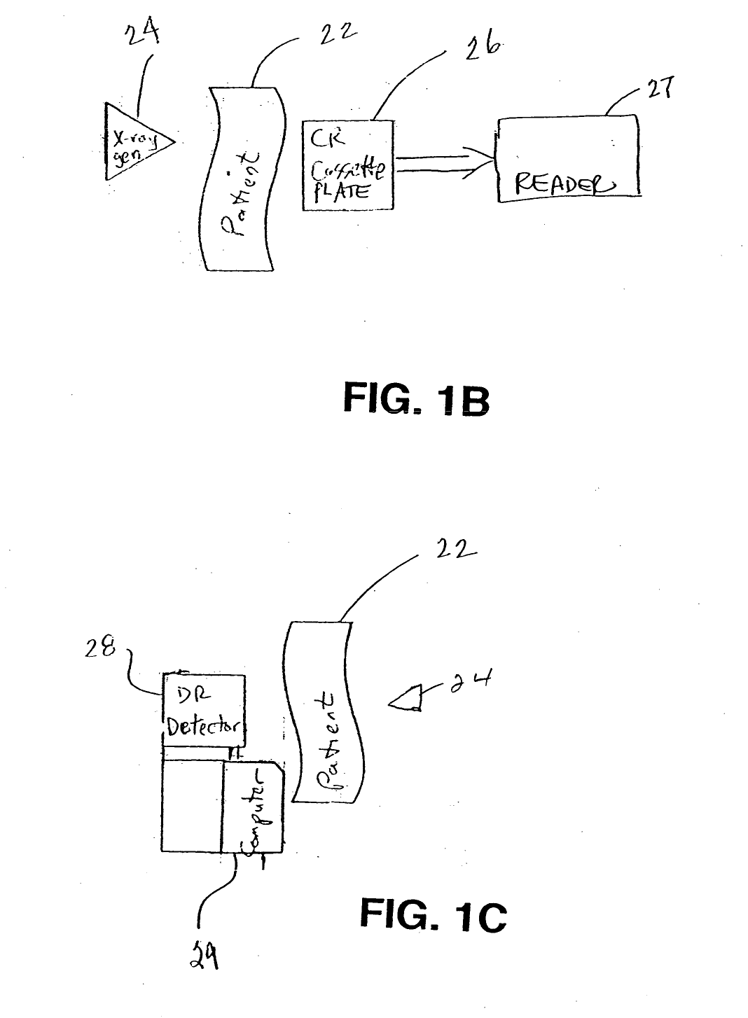

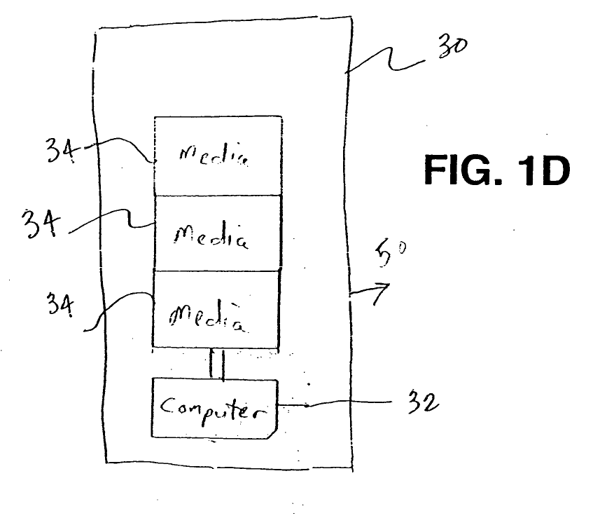

It is noted that the present invention can be implemented using one or more computers connected by means of a communications network. FIG. 1A shows a diagrammatic illustration showing a digital medical imaging system 10 suitable for practicing the present invention, comprised of a capture device 20, an image archive 30, and an image display device 40, such as a diagnostic viewing workstation 40, in communication by means of a communication network 50.

Communications network 50 illustrated in FIG. 1A provides a means of sending and receiving information between any two or more connected computers. A communications network may include physical connections from one computer to another such as can be achieved with a conventional Ethernet communications network. It is also possible for the communications network to include non-physically connected communications lines such as can be achieved with microwave communications links, radio communications links, coaxial cable television communications links, fiber optic communication links, satellite communication links, or cellular telephone communications links. Thus, the present invention may be practiced with any of the communications systems mentioned above, but is not limited solely to these systems since the present invention relies on exchange of information not the means of achieving the exchange of information.

Capture device 20 is a digital medical image capture device, and represents a projection radiographic device that produces digital x-ray images, such as, but not limited to, Computed Radiography (CR) and Digital Radiography (DR). Capture device 20 can include a display 21 for viewing the captured medical image.

Referring to FIG. 1B, with a CR capture device, a digital medical image is captured by exposing a patient 22 to an x-ray beam from an x-ray source 24 that is collected on a storage phosphor material, such as a CR cassette 26 and then scanner/reader using a CR reader 27. Reader 27 and/or a computer can also apply enhancement processing to the image.

Referring to FIG. 1C, with a DR capture device, a digital detector 28 collects the x-ray beam from x-ray source 24 projected through patient 22 to generate a digital medical image. Once the digital medical image is acquired/captured, enhancement processing can be applied to the captured image using a processing device such as a computer 29.

The resulting processed image from capture device 20 can then be transmitted by means of communications network 50 to image archive 30, diagnostic workstation 40, and/or any other device in communication with network 50. In practice, as shown in FIG. 1D, image archive 30 can be comprised of a computer 32 and gigabytes to terabytes of image storage media 34. Images can be transmitted from image archive 30 to diagnostic workstation computer 40 by means of communications network 50. At diagnostic workstation 40, a user (such as a radiologist) 45 (FIG. 1A) would review the image and make a diagnosis. Various PACS configurations are possible, and some configurations may combine the image archive function with the diagnostic workstation function.

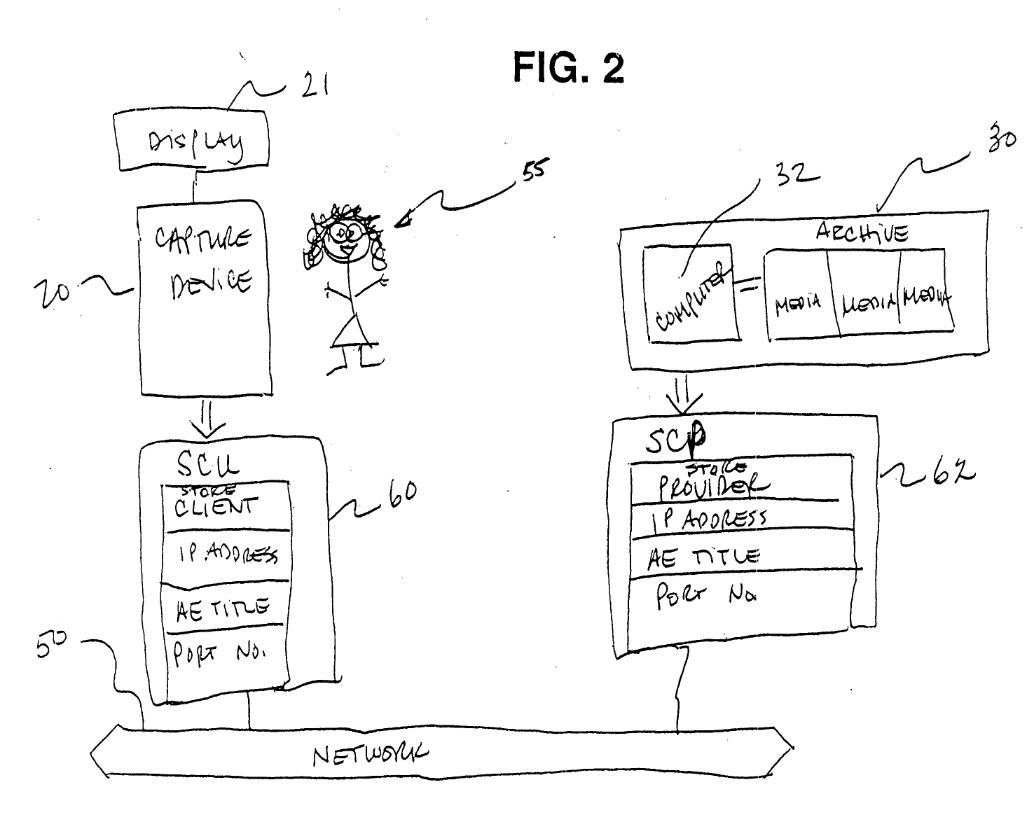

The process of transmitting a digital medical image from a capture device is shown in more detail in FIG. 2. Capture device 20 is an example of a digital medical image capture device, but the method of this invention is not limited to a specific medical image modality. Typically, a user (such as a radiological technologist) 55 examines each captured image on the modality display 21 to ensure the quality of the captured image is suitable for interpretation. For example, a radiological technologist 55 may verify correct patient positioning was achieved and that patient motion did not degrade the image utility. Typically, the radiological technologist 55 will optionally adjust image enhancement processing parameters, such as, but not limited to, window center and window width. If the radiological technologist 55 deems that the image is acceptable, the technologist 55 will direct that the image be sent to one or more DICOM Service Class Providers (SCP). Image archive computer 30 can function as a DICOM Store SCP.

The reader/computer (i.e., FIG. 1B-27, FIG. 1C-29) of the capture device performs the function of a DICOM Service Class User (SCU), or client, of the image archive (store provider). The DICOM standard does not provide a mechanism for an SCU to search the communications network for any available computers that are performing as an SCP. Therefore, a digital medical capture device in its role of DICOM SCU must keep or have access to a database of available Service Class Providers. The radiological technologist 55 will be presented with a list of destinations (SCP) from which to choose, or the computer may be configured to automatically send the image to specified destinations when the radiological technologist 55 accepts the image.

The DICOM standard provides a specific and detailed mechanism for an SCU (i.e., client/user) to communicate with an SCP (i.e., provider). Still referring to FIG. 2, this mechanism includes a means of uniquely identifying a client 60 and a provider 62 by the specification of Internet Protocol (IP) address, Application Entity (AE) title, and port number. This identification information, along with DICOM specifications for message exchange and network communications support for message exchange, allows a digital medical image to be transmitted from client to provider. A component of the present invention may be implemented as a software application running on the image archive's computer 32 such that a client identification (including an IP address, AE title, and port number) are recorded permanently in association with other unique medical image identifiers and source or origin attributes for each image transmitted and received. Those unique medical image identifiers include, but are not limited to, the identifiers required by the DICOM Information Object Definitions (IOD) for projection radiography systems, such as Service-Object Pair (SOP) Instance Unique Identifier (UID) (DICOM attribute number 0x0008,0x0018), Study Instance UID (0x0020,000d), and Series Instance UID (0x0020,000e).

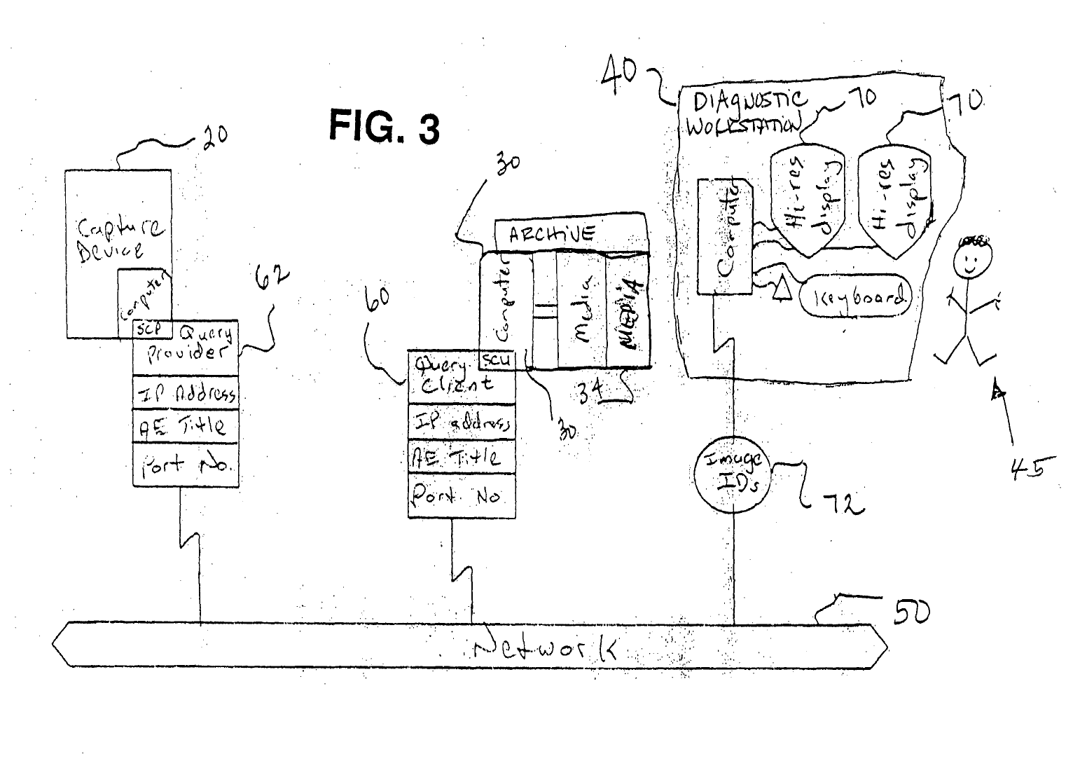

FIG. 3 more particularly illustrates diagnostic workstation 40 where a radiologist 45 examines the digital medical image in order to extract any relevant diagnostic information. Diagnostic workstation 40 is equipped with at least one (typically from one to four) high resolution grayscale image display monitor 70. These monitors are usually capable of displaying (in portrait mode), from 1536 columns by 2048 rows up to 2048 columns by 5000 rows, or three to five million pixels of information. Image display monitors 70 are high cost, finely calibrated devices intended to provide the optimum image viewing conditions that expose maximum diagnostic detail. These image display monitors are in contrast to the typical display shown in FIG. 2 as display 21 associated with capture device 20. Display 21 attached to capture device 20 is typically no more than 1024 columns by 768 rows, and is often a touch screen monitor where image quality is limited by a touch sensing device built into the screen and fingerprints that naturally accumulate on the screen. Furthermore, the radiological technologist 55 illustrated in FIG. 2 typically does not have the training and qualifications to determine the optimal image enhancement processing that will expose maximum diagnostic detail.

When an unenhanced digital medical image is enhanced by capture device 20 (FIG. 2), the enhanced digital image contains an equal or less amount of mathematical information than the unenhanced digital image. That is, in effect, some mathematical information is lost in the transformation from the unenhanced digital image to the enhanced digital image in order to condition the image information so that radiologist, or other qualified medical personnel can see more image detail.

The present invention provides, in the form of one or more software programs and databases operating on diagnostic workstation 40, image enhancement processing capability that can be used as a substitute for the image processing performed by capture device 20. The ability to apply image enhancement processing on diagnostic workstation 40 provides an advantage over equivalent processing on capture device 20 since the diagnostic workstation has one or more high resolution image display monitors 70, and the image enhancement processing parameter selection is conducted by medical personnel qualified to review the medical image rather than medical personnel who operate image capture device 20.

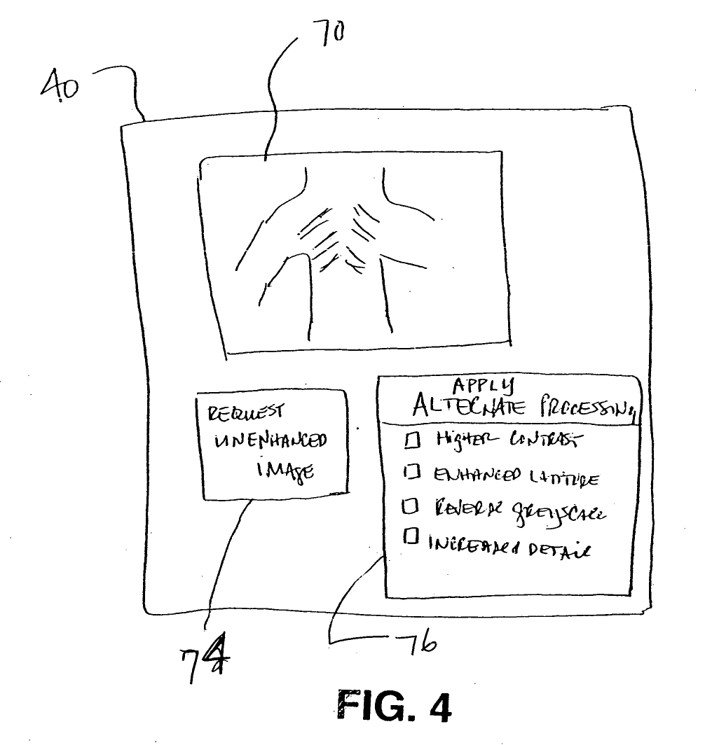

The present invention provides a mechanism, in the form of one or more software programs running on diagnostic workstation 40 in FIG. 3, for a radiologist 45 or other qualified medical personnel to request an unenhanced copy of the image being evaluated. This mechanism can be, but is not limited to, a user interface button activated by a mouse click, a touchscreen button (illustrated in FIG. 4), a menu item command, or a voice activated command. The present invention further provides a mechanism for one or more software programs to implement the request for an unenhanced copy of the image by making a request for the image from image archive 30. The request specifies the image by one or more identifiers 72 associated with the image and known to the software running on diagnostic workstation 40 by virtue of the existence of the enhanced version of the image on diagnostic workstation 40.

The request for an unenhanced copy of an image is transmitted from diagnostic workstation 40 to image archive 30 by means of one or more software programs, not necessarily using any of the DICOM standards. It is noted that image archive 30 has the ability to resolve the IP address, AE title, and port number associated with each and every image it has received. In a preferred embodiment of the present invention, this is achieved by searching media 34 in image archive 30 that records this information for each image received by image archive 30.

The present invention further provides a mechanism for image archive 30 to query capture device 20 for a copy of an image in an unenhanced form. In a preferred embodiment of the present invention, only the actual capture device that produced the image that is the subject of the query is queried for the unenhanced data because the information is resolved from records stored on image archive 30's media 34. This mechanism can be, but is not restricted to, a software implementation of the DICOM query client 60 running on image archive computer 30 in association with a DICOM query provider 62 running on capture device 20. If the capture device 20 responds positively to the query for an image in unenhanced form (i.e., that the requested image is available for transmission), then capture device 20 assumes the role of DICOM store client 60 to image archive 30 in its role as DICOM store provider 62 as illustrated in FIG. 2. The present invention as described above can also be implemented in similar fashion when the diagnostic workstation also performs the functions of an image archive as is commonly done in small scale PACS installations.

In an alternative embodiment of the present invention, another networked computer, such as, but not limited to image archive computer 30 illustrated in FIG. 2, can have one or more software programs that examine the attributes of digital medical images stored to the archive that already have enhancement processing applied. Certain attributes, such as the body part examined (DICOM attribute number 0x0018, 0x0015) can be evaluated automatically to see if the attribute matches criteria specified to trigger a request for an unenhanced copy of the image. While the enhanced image may be suitable for making diagnostic interpretations when displayed on a high resolution monitor 70 by a radiologist, as shown in FIG. 3, computer aided detection (CAD) algorithms for identifying possible or probable lung nodules in chest images or micro-calcifications in breast images may perform better on unenhanced data since CAD algorithms typically make advantageous use of the additional mathematical information contained in the unenhanced image. In this alternative embodiment of the present invention, image archive computer 30 can automatically recognize that an image meets specified image attribute criteria, then automatically perform the function of a query client 60, requesting an unenhanced copy of the image from capture device 20 in its role as a query provider. The unenhanced image can then be transmitted to a CAD algorithm running on image archive 30 or some other computer designated for this operation on area network 50. The unenhanced image can then be processed to generate a modified digital medical image which aids the user in interpreting the digital medical image. The applied algorithm can also produce a report (a “Structured Report in DICOM terms) which aids the user in interpreting abnormalities of a body part presented by the original image or the modified digital medical image. The report can include textual and/or graphical information, such as circles or arrows that can draw attention to a possible abnormality, such as a lung nodule.

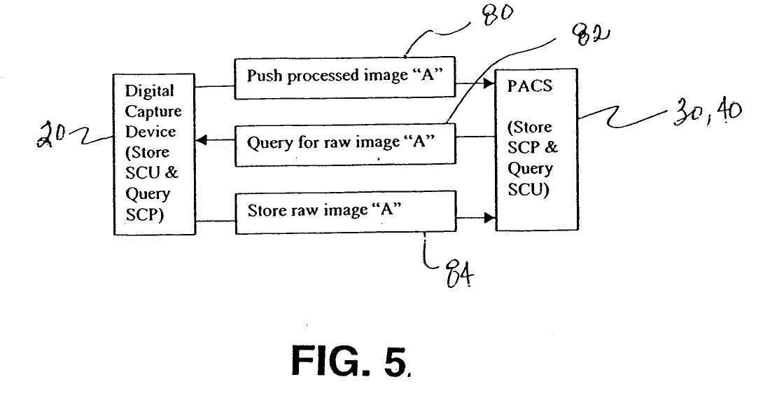

An implementation of the present invention is more particularly illustrated in FIG. 5. The capture device 20 captures and processes the unenhanced image (i.e., raw image) to generate the enhanced image (i.e., processed image). This enhanced image is then pushed (i.e., sent) to image archive 30 or diagnostic workstation 40 (or other PACS element) (step 80 in FIG. 5). In some situations, the radiologist may be unable to read the image due to inadequate or incorrect image processing. That is, if a radiologist is reviewing the enhanced image at diagnostic workstation 40, the radiologist may desire to view the image with different processing (for example, higher contrast, enhanced latitude, reverse grayscale, or increased detail) so as to better diagnosis the image. Accordingly, the technologist can request an unenhanced copy of the image being evaluated to capture device 20 (step 82 in FIG. 5), using, for example, the touchscreen/activation button 74 shown in FIG. 4. The unenhanced image can then be sent from capture device 20 to diagnostic workstation 40 (step 84). Alternate processing can then be applied at diagnostic workstation 40 in response to instructions indicated by the technologist (as shown in FIG. 4 at 76).

Although the DICOM protocol has been described as useful with the present invention, it will be understood that other protocols can be used within the scope of the present invention. The term “diagnostic workstation” is exemplary only and can include any image display device (typically high resolution) with associated control system (workstation) or other computer.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

10—digital medical imaging system
20—capture device
21—display
22—patient
24—x-ray source
26—CR cassette
27—CR reader
28—digital detector
29—computer
30—archive
32—computer
34—image storage media
40—diagnostic viewing workstation
45—user (radiologist)
50—communication network
55—user (radiological technologist)
60—client
62—provider
70—monitor
72—identifier
74—activation button
76—alternate processing instructions
80, 82, 84—steps

What is claimed is:

1. A method for distributing digital medical images between an image capture device and image display device remote from the image capture device, comprising the steps of:
accessing an enhanced digital medical image at the image display device, the enhanced digital medical image being generated by applying a first image processing to an unenhanced digital medical image acquired by and stored at the image capture device;
allowing a user to initiate a request from the image display device for the unenhanced digital medical image;
transmitting the request from the image display device to the image capture device; and
transmitting the unenhanced digital medical image from the image capture device to the image display device.

2. The method of claim 1, further comprising the steps of:
applying a second processing to the unenhanced digital medical image at the image display device to generate a modified enhanced digital medical image; and
displaying the modified enhanced digital medical image on the image display device.

3. The method of claim 1, further comprising the steps of:
at the image display device, displaying a plurality of processing candidates;
allowing a user to select at least one of the plurality of processing candidates;
processing the unenhanced digital medical image at the image display device to generate a modified enhanced digital medical image representative of the selected processing candidate; and
displaying the modified enhanced digital medical image on the image display device.

4. The method of claim 1, wherein the step of allowing a user to initiate the request is accomplished by providing selection means on the image display device, which when selected, transmits the request.

5. The method of claim 1, wherein the step of transmitting the request from the image display device to the image capture device is accomplished by the step of:
directly transmitting the request from the image display device to the image capture device.

6. The method of claim 1, wherein the step of transmitting the request from the image display device to the image capture device is accomplished by the steps of:
transmitting a first request from the image display device to an image archive; and
transmitting a second request from the image archive to the image capture device.

7. The method of claim 1, wherein the step of transmitting the request from the image display device to the image capture device is accomplished by the steps of:
transmitting a first request from the image display device to an image archive; and
transmitting a DICOM query provider request from the image archive to the image capture device, wherein the image capture device is a DICOM query provider.

8. The method of claim 1, further comprising the steps of;
at the image display device, displaying a plurality of processing candidates;
allowing a user to select at least one of the plurality of processing candidates;
processing the unenhanced digital medical image at the image display device to generate a modified enhanced digital medical image; and
displaying the modified enhanced digital medical image on the image display device.

9. The method of claim 1 wherein said image capture device is one of a computed radiography device and a direct digital radiography device.

10. The method of claim 3 including replacing the enhanced digital medical image with the modified enhanced digital medical image in storage.

11. A method for processing a digital medical image for computer aided analysis, comprising the steps of:
accessing an enhanced digital medical image at an image display device or other computer on a network including the image display device and other computer, the enhanced digital medical image being generated by applying a first image processing to an unenhanced digital medical image acquired by an image capture device, the image capture device being remote from the image display device;
analyzing the enhanced digital medical image to determine if the enhanced digital medical image includes predetermined image attribute values;
if the enhanced digital medical image includes the predetermined image attribute values, then automatically requesting the unenhanced digital medical image from the image capture device;
transmitting the unenhanced digital medical image from the image capture device to the image display device or other computer;
applying an algorithm to the unenhanced digital medical image to generate a modified digital medical image and/or a report; and
displaying the modified digital medical image and/or the report on the image display device or other computer.

12. The method of claim 11 wherein the step of applying an algorithm generates a modified digital medical image which aids the user in interpreting the digital medical image.

13. The method of claim 12 wherein the applied algorithm generates a report which aids a user in interpreting abnormalities of a body part presented by the original or the modified digital medical image.

14. The method of claim 13 wherein the report can be one or more of textual or graphical information, such as circles or arrows, that draw attention to a possible bodypart abnormality.
